(19) United States
(12) Patent Application Publication
(10) Pub. No.: US 2018/0207674 A1
(43) Pub. Date: Jul. 26, 2018

(54) ADHESIVE MATERIAL APPLYING APPARATUS

(71) Applicant: BOE TECHNOLOGY GROUP CO., LTD., Beijing (CN)

(72) Inventor: Zhiqiang Jiang, Beijing (CN)

(73) Assignee: BOE TECHNOLOGY GROUP CO., LTD., Beijing (CN)

(21) Appl. No.: 15/329,092

(22) PCT Filed: Aug. 24, 2016
(86) PCT No.: PCT/CN2016/096556

§ 371 Date: Jan. 25, 2017

(30) Foreign Application Priority Data
Jan. 4, 2016 (CN) 201610003761.1

(51) Int. Cl. B05C 11/10; B05C 5/00

(52) U.S. Cl. CPC B05C 11/1042; B05D 5/10; B05C 5/00

(57) ABSTRACT

An adhesive material applying apparatus includes a storage cavity (1) for storing an adhesive material and a cooling layer (9) arranged on an outer wall of the storage cavity (1) for cooling the storage cavity (1). The adhesive material applying apparatus can keep a constant temperature and maintain the viscosity coefficient of the adhesive material so that stability and uniformity of adhesive applying are improved.

### TECHNICAL FIELD

Embodiments of the present disclosure relate to an adhesive dispensing and applying process in an Organic Light Emitting Diode (OLED) packaging process.

### BACKGROUND

An Organic Light Emitting Diode (OLED) is known as a next generation of display technology, and it has a wide developing prospect due to advantages, such as high illumination brightness, rich color, capability of being manufactured into flexible display and the like. An OLED device is very sensitive to water vapor and oxygen; the water vapor and the oxygen which permeates into the OLED device can affect a service life of the OLED device, so a protective layer is made on the OLED device by a packaging technology and can stop permeation of the water vapor and the oxygen to prolong the service life of the OLED device, and the encapsulating technology widely used in the industry adopts a process of applying an adhesive material or pasting a thin film to the device.

### SUMMARY

An embodiment of the present disclosure provides an adhesive material applying apparatus, including a storage cavity configured to store an adhesive material; and a cooling layer arranged on an outer wall of the storage cavity and configured to cool the storage cavity.

For example, the cooling layer has a uniform thickness.

For example, both the storage cavity and the cooling layer are needle cylinder-liked.

For example, the cooling layer is provided with an inlet and an outlet configured to cool the storage cavity by circulating cooling water therethrough.

For example, the inlet is provided at a lower portion of the cooling layer, and the outlet is provided at an upper portion of the cooling layer.

For example, the adhesive material applying apparatus further includes a temperature sensor configured to monitor a temperature variation of cooling water in the cooling layer. When the temperature is over a preset value, flow of the cooling water is adjusted automatically.

For example, the storage cavity and the cooling layer are made of a transparent material. Two sets of liquid level sensors are provided at upper portion and lower portion outside the cooling layer and configured to detect a position of a liquid level of the adhesive material. If the liquid level in the storage cavity is lower than a position of the sensor at the lower portion, the adhesive material is supplied through a supplying port of the adhesive material. If the liquid level reaches a position of the sensor at upper portion, the adhesive supplying is stopped.

For example, the liquid level sensor is an opposite-type optical liquid level sensor.

### BRIEF DESCRIPTION OF THE DRAWINGS

Embodiments of the present disclosure will be illustrated in more details in connection with the drawings so as to enable those skilled in the art to understand the disclosure more clearly, in which,

FIG. 1 is a sectional structural schematic diagram of an adhesive material applying apparatus;

FIG. 2 is a schematic diagram of an adhesive material coated on a cover board glass;

FIG. 3 is a sectional structural schematic diagram of an adhesive material applying apparatus according to an embodiment of the present disclosure; and

FIG. 4 is a structural top-view of the adhesive material applying apparatus according to an embodiment of the present disclosure.

### DETAILED DESCRIPTION

Technical solutions according to the embodiments of the present disclosure will be described clearly and understandable as below in conjunction with the accompanying drawings of embodiments of the present disclosure. It is apparent that the described embodiments are only part of but not all of exemplary embodiments of the present disclosure. Based on the described embodiments of the present disclosure, various other embodiments can be obtained by those of ordinary skill in the art without creative labor and those embodiments shall fall into the protection scope of the present disclosure.

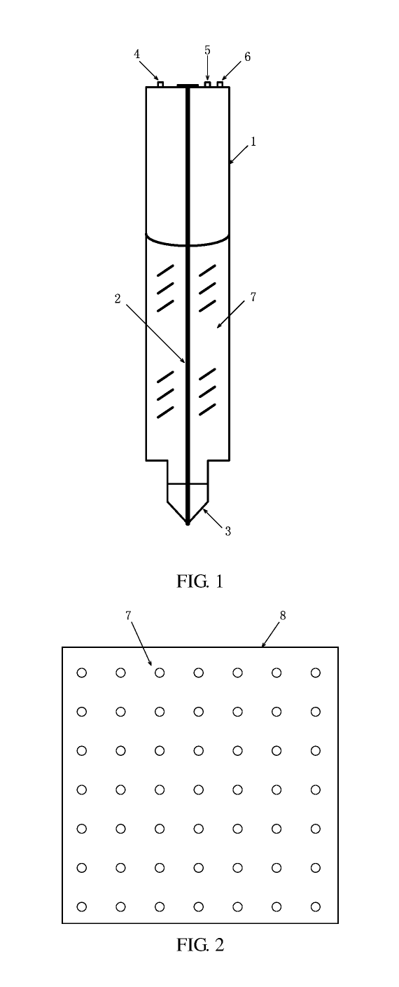

FIG. 1 is a sectional structural schematic diagram of an adhesive material applying apparatus. The adhesive material applying apparatus includes a storage cavity 1. An ejector pin 2 is disposed inside the storage cavity 1, a spray nozzle 3 is arranged at a lower portion of the storage cavity 1, and an upper portion of the storage cavity 1 is connected with a pressurizing port 4, an exhaust port 5 and an adhesive material filling port 6. When the applying apparatus is used, firstly, the exhaust port 5 is opened, an adhesive material 7 is injected into the storage cavity 1 through the adhesive material filling port 6, the exhaust port 5 is closed after injection is completed, and then nitrogen gas is filled into the storage cavity 1 by the pressurizing port 4. In the process that the ejector pin 2 moves upwards, due to the air pressure, the adhesive material 7 is squeezed downwards along an inner wall of the storage cavity 1 and is dropped out by the spray nozzle 3; at the moment, positions on a cover board glass, which need to be coated with the adhesive material, just move to the position below the spray nozzle 3 by a conveyor, and the adhesive material 7 is uniformly coated at the corresponding positions on the cover board glass. FIG. 2 is a schematic diagram after the adhesive material is coated on the cover board glass.

The inventor notices that when used, if operation is carried out for long time, the ejector pin frequently impacts the spray nozzle and rubs the adhesive material to generate heat, so the temperature of the adhesive material would be increased, and the viscosity coefficient of the adhesive material and uniformity of the dropped adhesive material would be decreased, so that the stability of applying the adhesive would be impacted.

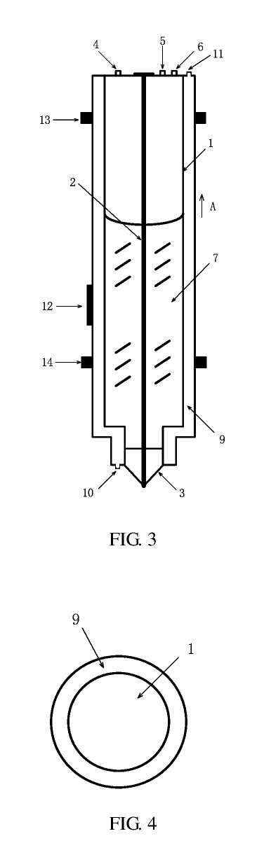

FIG. 3 is a schematic structural diagram of an adhesive material applying apparatus in an embodiment of the present disclosure. As shown in FIG. 3, the adhesive material applying apparatus of the embodiment of the present disclosure includes a storage cavity 1, an ejector pin 2, a spray nozzle 3, a pressurizing port 4, an exhaust port 5, an adhesive material filling port 6 and a cooling layer 9.

A cavity of the storage cavity 1 is used for storing an adhesive material 7. For example, the storage cavity 1 is a needle cylinder-liked shape, but the embodiments of the present disclosure are not limited thereto. For example, the storage cavity 1 can also be other shapes.

When the applying apparatus is used, firstly, the exhaust port 5 is opened, the adhesive material 7 is injected into the storage cavity 1 by the adhesive material filling port 6, the exhaust port 5 is closed, and then nitrogen gas is filled into the storage cavity 1 through the pressurizing port 4. In the process that the ejector pin 2 moves upwards, due to the action of the air pressure, the adhesive material 7 is squeezed downwards along the inner wall of the storage cavity 1 and is dropped out through the spray nozzle 3; at the moment, positions on a cover board glass, which need to be coated with the adhesive material, just move to the position below the spray nozzle 3 by a conveyor, and the adhesive material 7 is coated at the corresponding positions on the cover board glass. The ejector pin reciprocates along an up-and-down direction, so that a certain quantity of adhesive material is dropped out according to process requirements.

The cooling layer 9 is arranged on the outer wall of the storage cavity, circulating cooling water is filled in the cooling layer. The cooling water can cool the cavity wall and the adhesive material to allow the temperature of the adhesive material to be constant and maintain the viscosity coefficient of the adhesive material so as to improve the applying stability. Optionally, as shown in FIG. 3 and FIG. 4, the cooling layer has a uniform thickness, and it has a shape consistent with the storage cavity and is needle cylinder-liked.

Moreover, for example, a cooling system is also provided with an inlet 10 and an outlet 11, and both the inlet 10 and the outlet 11 are connected with the outside by a rubber tube. In this way, the cooling water is connected with the inlet by the rubber tube and the flow rate is controlled by an external valve, then, after the rubber tube is connected with the outlet to form a passage, cooling is carried out. A circulating passage of a liquid refrigerant can be formed by water cooling apparatus together, e.g., a common circulating pump or the like in the industrial production, and those skilled in the art can carry it out according to the application situation, which is not described in details herein.

Optionally, to effectively bring away high heat at the bottom of the storage cavity and maintain an uniform internal temperature, the inlet is disposed at the lower portion of the body of the storage cavity, the outlet is disposed at the upper portion of the cavity body, so that the cooling water flows along an A direction in FIG. 3, so that a better cooling effect is achieved.

For example, the applying apparatus also includes a temperature sensor 12. For example, an intelligent temperature sensor with a display screen may be used, so as to more accurately and visually monitor a temperature variation of the cooling water in the cooling layer. The temperature sensor is connected with a controller, and the controller operates and controls an external valve to control flow of the cooling water according to monitoring data of the temperature sensor. When the temperature exceeds a preset value, the flow of the cooling water is automatically regulated so as to allow a constant temperature of the adhesive material and uniformity of adhesive dispensing. For example, the temperature sensor is arranged on the outer wall of the cooling layer so as to reduce the process difficulty and facilitate device maintenance.

In the above technical solution, a contact-type temperature sensor, such as a thermocouple temperature sensor, a thermistor temperature sensor, an optical fiber bragg grating temperature sensor or the like can be used as the temperature sensor.

In addition, in order to monitor the residual quantity of the adhesive material, a liquid level sensor is also arranged for detecting a position of a liquid level of the adhesive material. For example, the liquid level sensor is arranged on the outer wall of the cooling layer so as to facilitate device maintenance. Light has different penetration rates in gas and the adhesive material, so an opposite-type optical liquid level sensor can be adopted. Each set of opposite-type optical liquid level sensor includes a transmitter and a receiver; and the transmitter and the receiver of each set are oppositely arranged in a split mode at the same height of the outer wall of the cooling layer to carry out liquid level detection. For example, two sets of liquid level sensors are provided outside the storage cavity, and arranged at the upper portion and the lower portion of the storage cavity 1, respectively. For example, a high liquid level sensor 13 and a low liquid level sensor 14 shown in FIG. 3. But the embodiments of the present disclosure are not limited thereto. Cooperatively, to avoid blocking detection light, both the storage cavity and the cooling layer are made of a transparent material. The transparent material can be polyethylene, for example, but the embodiments of the present disclosure are not limited thereto. For example, other suitable transparent materials also can be used. The liquid level of the adhesive material in the storage cavity is lower than the low liquid level sensor, the adhesive material is supplied or supplemented by the adhesive material filling port; and when the liquid level reaches the high liquid level sensor, the supplying or supplementing of the adhesive material is stopped, so that automatic filling of the adhesive material is implemented, and production efficiency is improved.

Through the above analysis, it can be seen that in the adhesive material applying apparatus according to the embodiment of the present disclosure, the cooling layer is arranged on the outer wall of the storage cavity and is filled with the circulating cooling water to cool the cavity so as to cool the adhesive material of which the temperature may be risen in a long-time production process; and the temperature variation of the cooling water in the cooling layer is monitored by the temperature sensor, and the constant temperature of the adhesive material is more accurately and visually controlled, as well as the viscosity coefficient of the adhesive material is maintained, so that the stability and uniformity of adhesive dispensing are improved and the technical process of OLED adhesive material applying is optimized.

The foregoing exemplary embodiments are merely for illustrating the technical solutions of the present disclosure, and not intended to limit the present disclosure. Although the embodiments of the present disclosure are illustrated in details with reference to the foregoing embodiments, an ordinary skill in the art should understand that modifications can be made to the technical solutions recorded in the foregoing embodiments, or equivalent replacements can be made to part of technical features; and those modifications and replacements do not make the essences of the corresponding technical solutions depart from the spirit and scope of the technical solutions of the embodiments of the present disclosure.

The present application claims priority to and benefits of the Chinese Patent Application No. 201610003761.1 filed on Jan. 4, 2016 and entitled “ADHESIVE MATERIAL APPLYING APPARATUS,” the entire contents of which are incorporated herein by reference.

1. An adhesive material applying apparatus, comprising:
a storage cavity configured to store an adhesive material; and
a cooling layer arranged on an outer wall of the storage cavity and configured to cool the storage cavity.

2. The adhesive material applying apparatus according to claim 1, wherein the cooling layer has a uniform thickness.

3. The adhesive material applying apparatus according to claim 1, wherein both the storage cavity and the cooling layer are needle cylinder-liked.

4. The adhesive material applying apparatus according to claim 1, wherein the cooling layer is provided with an inlet and an outlet.

5. The adhesive material applying apparatus according to claim 4, wherein the inlet is provided at a lower portion of the cooling layer, and the outlet is provided at an upper portion of the cooling layer.

6. The adhesive material applying apparatus according to claim 1, further comprising a temperature sensor configured to monitor a temperature variation of cooling water in the cooling layer.

7. The adhesive material applying apparatus according to claim 6, wherein the temperature sensor is arranged on an outer wall of the cooling layer.

8. The adhesive material applying apparatus according to claim 1, further comprising a liquid level sensor configured to monitor a position of a liquid level of the adhesive material.

9. The adhesive material applying apparatus according to claim 8, wherein the liquid level sensor is arranged on the outer wall of the cooling layer.

10. The adhesive material applying apparatus according to claim 8, wherein the liquid level sensor is an opposite-type optical liquid level sensor.

11. The adhesive material applying apparatus according to claim 10, wherein both the storage cavity and the cooling layer are made of a transparent material.

12. The adhesive material applying apparatus according to claim 8, wherein two sets of liquid level sensors are provided and arranged at the upper portion and the lower portion of the storage cavity, respectively.

13. The adhesive material applying apparatus according to claim 10, wherein both the storage cavity and the cooling layer are made of polyethylene.

14. The adhesive material applying apparatus according to claim 6, wherein the temperature sensor is a contact-type temperature sensor selected from a group consisting of a thermocouple temperature sensor, a thermistor temperature sensor, an optical fiber bragg grating temperature sensor or the like.

15. The adhesive material applying apparatus according to claim 1, wherein both the storage cavity and the cooling layer are needle cylinder-liked.

16. The adhesive material applying apparatus according to claim 3, wherein the cooling layer is provided with an inlet and an outlet.

17. The adhesive material applying apparatus according to claim 16, further comprising a temperature sensor configured to monitor a temperature variation of cooling water in the cooling layer.

18. The adhesive material applying apparatus according to claim 17, further comprising a liquid level sensor configured to monitor a position of a liquid level of the adhesive material.

19. The adhesive material applying apparatus according to claim 18, wherein the liquid level sensor is an opposite-type optical liquid level sensor.
